(19) United States
(12) Patent Application Publication
(10) Pub. No.: US 2007/0093240 A1
(43) Pub. Date: Apr. 26, 2007

(54) FILE TRANSFERRING SYSTEM AND METHOD

(75) Inventors: Kuan-Hong Hsieh, Shenzhen (CN); Xiao-Guang Li, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,525

(22) Filed: Aug. 17, 2006

(30) Foreign Application Priority Data
Oct. 21, 2005 (CN) 200510100572.8

(51) Int. Cl. H04M 3/00

(52) U.S. Cl. 455/418

(57) ABSTRACT

A file transferring method is provided. The method includes the steps of: receiving a send request for a selection of one or more media files from a first cell phone, wherein the send request comprises an identification (ID) or a title of each media file selected, and a recipient cell phone number; generating a receive request corresponding to the send request, and transmitting the receive request to the recipient cell phone, wherein the receive request comprises a number of the first cell phone, the ID code or the title of each media file selected, and a location indicating where each media file content is stored; and transmitting the media files selected to the recipient cell phone when the recipient cell phone establishes a data connection. A corresponding system is also provided.

### TECHNICAL FIELD

The present invention relates to file processing systems and methods, and particularly to a file transferring system and method.

### GENERAL BACKGROUND

Cell phones is a popular choice for people to communicate with each other. Cell phones now have special functions allowing a user to transfer a multimedia file such as a sound file to a recipient. In a method, the multimedia file sender would use a cell phone to select and send a multimedia file to a recipient. The recipient must dial a voice number via his/her cell phone so as to listen to the media file when the recipient receives a notification via his/her cell phone. However, the timbre is not very good. In addition, a service system will deduct a toll of the media files as long as the media files are successfully transmitted to the recipient.

Another kind of file transferring methods is by using multimedia message service (MMS) to exchange multimedia files between cell phones. However, MSS exchanges are only applicable only if both the sender and the recipient cell phone support or subscribe to MMS that is provided by their corresponding service providers. A service would increase the cost when purchasing a cell phone or when subscribing to a service provider.

Thus, a file transferring system and method which can solve the above-described problems is desired.

### SUMMARY

A file transferring system is provided. The system includes a plurality of cell phones and a server. The server includes a storage device for storing a plurality of media files; a transmitter; a receiver for receiving a send request for a selection of one or more media files from a first cell phone, wherein the send request comprises an identification (ID) code or a title of each media file selected, and a recipient cell phone number; and a control unit for generating a receive request corresponding to the send request, wherein the receive request comprises a number of the first cell phone, the ID code or the title of each media file selected, and a location indicating where each media file is stored, signaling the transmitter to transmit the receive request to the recipient cell phone, and transmitting the media files selected to the recipient cell phone when the recipient cell phone establishes a data connection with the server.

A file transferring system is also provided. The method includes the steps of: (a) receiving a send request for a selection of one or more media files from a first cell phone, wherein
the send request comprises an identification (ID) or a title of each media file selected, and a recipient cell phone number; (b) generating a receive request corresponding to the send request, and transmitting the receive request to the recipient cell phone, wherein the receive request comprises a number of the first cell phone, the ID code or the title of each media file selected, and a location indicating where each media file content is stored; and (c) transmitting the media files selected to the recipient cell phone when the recipient cell phone establishes a data connection.

Other advantages and novel features will be drawn from the following detailed description of the embodiments with reference to the attached drawings, in which:

### BRIEF DESCRIPTION OF DRAWINGS

FIG. 1 is a block diagram of a file transferring system in accordance with a preferred embodiment of the present invention; and

FIG. 2 is a flowchart of a preferred file transferring method by implementing the system of FIG. 1.

### DETAILED DESCRIPTION OF THE PREFERRED EMBODIMENT

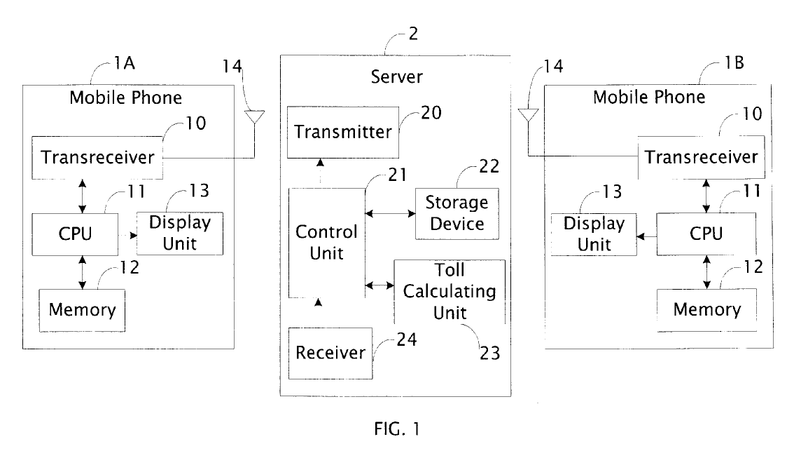

FIG. 1 is a block diagram of a file transferring system (hereafter, “the system”) in accordance with a preferred embodiment of the present invention. The files are media files. The system includes a plurality of cell phones 1 and one or more servers 2 (only one shown in FIG. 1). Each cell phone 1 includes a transceiver 10, a central processing unit (CPU) 11, a memory 12, a display 13, and an antenna 14. The server 2 includes a transmitter 20, a control unit 21, a storage device 22, a toll calculating unit 23, and a receiver 24.

In the preferred embodiment, the system adopts two cell phone 1A and 1B as an example. The cell phone 1A is for sending a send request of a selection of one or more media files that will be transferred from the server 2 to the cell phone 1B, whereas, the cell phone 1B downloads the media files that has been selected by the cell phone 1A from the server 2. However, in other embodiment, the cell phone 1A can also download the selected files from the server 2 by itself.

The memory 12 of the plurality of cell phones 1 stores information used or generated by the cell phone 1. The storage device 22 of the server 2 stores a media file list and information on each media file such as an identification (ID) code, a title, an artist(s), a composer, a producer, a location indicating where the media files are stored, etc. The cell phone 1A is further used for establishing a data connection with the server 2. The control unit 21 of the server 2 is for accessing the media file list in the storage device 22 and for transferring the media file list to the cell phone 1A. The CPU 11 of the cell phone 1 is used for selecting one or more media files from the media file list, and generating a send request. The send request includes an ID code and/or a title of each selected media file, and further includes a recipient cell phone number (I.e., a phone number of the cell phone 1B). The transceiver 10 of the cell phone 1A is used for transmitting the send request to the server 2 via the antenna 14 thereof.

The receiver 24 of the server 2 is used for receiving the send request. The control unit 21 of the server 2 is used for searching for the media files selected from the storage device 22 corresponding the send request, and for generating a receive request. The receive request includes the phone number of the cell phone 1A that sent the send request, the ID code or the title of each selected media file, and a location where the digital version of each media file is stored. The transmitter 20 of the server 2 is used for transmitting the receive request to the cell phone 1B.

The transceiver 10 of the cell phone 1B is used for receiving the receive request via the antenna 14 thereof, and for establishing a data connection with the server 2 to download the selection of one or more media files. The control unit 21 of the server 2 is used for detecting whether a download request for downloading the media files selected is received by the cell phone 1B. The toll calculating unit 23 is used for calculating a toll of the media files selected if the cell phone 1B has successfully downloaded the media files selected. The control unit 21 is for deducting the toll calculated by the calculating unit 23 from a balance of the cell phone 1A.

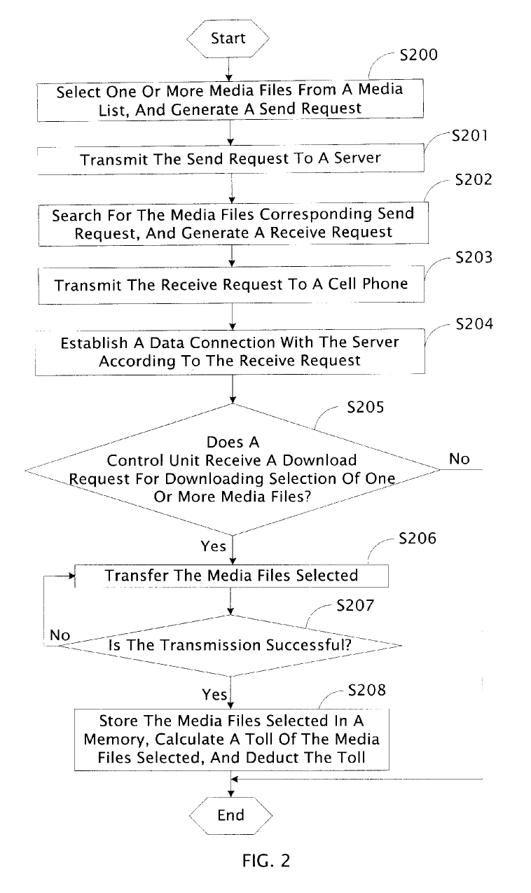

FIG. 2 is a flowchart of a preferred file transferring method by implementing the system of FIG. 1. In step S200, the CPU 11 of the cell phone 1A establishes a data connection with the server 2 via the transreceiver 10, the control unit 21 of the server 2 then accesses the media file list in the storage device 22 and transfers the media file list to the cell phone 1A. The CPU 11 of the cell phone 1 is then used to select one or more media files from the media file list, and generates the send request. The send request includes the ID code and/or a title of each media file selected, and the phone number of the recipient cell phone 1B. In step S201, the transceiver 10 of the cell phone MA transmits the send request to the server 2.

In step S202, the receiver 20 receives the send request, and the control unit 21 searches for the selected media files based on the send request, and generates the receive request. The receive request includes the phone number of the cell phone 1A, the ID code or the title of each media file selected, and a location where the digital version of each media file is stored. In step S203, the transmitter 20 sends the receive request to the cell phone 1B.

In step S204, the transceiver 10 of the cell phone 1B receives the receive request via the antenna 14, and the CPU 11 of the cell phone 1B establishes a data connection with the server 2 via the transreceiver 10 of the cell phone 1B to download the selection of one or more media files. In step S205, the control unit 21 detects whether it receives the download request for downloading the selection of one or more media files. If the control unit 21 does not receive the download request, the procedure is finished. Otherwise, in step S206, the control unit 21 transfers the media files selected to the cell phone 1B.

In step S207, the control unit 21 detects whether the transmission of the media files selected is successful. If so, the CPU 11 of the cell phone 1B stores the media files selected in the memory 12 thereof. The toll calculating unit 23 calculates a toll of the media files selected, and the control unit 21 deducts the toll from the balance of the cell phone 1A, whereupon the procedure is finished. Otherwise, the procedure returns to step S206 described above, the selected media files are downloaded again.

Although the present invention had been specifically described on the basis of the preferred embodiment including the preferred method, the invention is not to be construed as being limited thereto. Various changes or modifications may be made to the embodiment including the method without departing from the scope and spirit of the invention.

What is claimed is:

1. A file transferring system comprising a plurality of cell phones and a server, wherein:
the server comprises:
a storage device for storing a plurality of media files;
a transmitter;
a receiver for receiving a send request for a selection of one or more media files from a first cell phone, wherein the send request comprises an identification (ID) code or a title of each media file selected, and a recipient cell phone number; and
a control unit for generating a receive request corresponding to the send request, wherein the receive request comprises a number of the first cell phone, the ID code or the title of each media file selected, and a location indicating where each media file is stored, signaling the transmitter to transmit the receive request to the recipient cell phone, and transmitting the media files selected to the recipient cell phone when the recipient cell phone establishes a data connection with the server.

2. The system according to claim 1, wherein the control unit detects whether the recipient cell phone has successfully downloaded the media files selected.

3. The system according to claim 2, wherein the server further comprises a toll calculating unit for calculating a toll of the media files selected if the recipient cell phone has successfully downloaded the media files selected.

4. The system according to claim 3, wherein the control unit deducts the calculated toll from a balance of the first cell phone.

5. A file transferring method, the method comprising the steps of:
receiving a send request for a selection of one or more media files from a first cell phone, wherein the send request comprises an identification (ID) or a title of each media file selected, and a recipient cell phone number;
generating a receive request corresponding to the send request, and transmitting the receive request to the recipient cell phone, wherein the receive request comprises a number of the first cell phone, the ID code or the title of each media file selected, and a location indicating where each media file content is stored; and
transmitting the media files selected to the recipient cell phone when the recipient cell phone establishes a data connection.

6. The method according to claim 5, further comprising the step of detecting whether the recipient cell phone has successfully downloaded the media files selected.

7. The method according to claim 6, further comprising the step of calculating a toll of the files selected if the recipient cell phone has successfully downloaded the media files selected.

8. The method according to claim 7, further comprising the step of deducting the calculated toll from a balance of the first cell phone.
